(19) United States
(12) Patent Application Publication
(10) Pub. No.: US 2023/0225839 A1
(43) Pub. Date: Jul. 20, 2023

(54) METHODS AND SYSTEMS FOR OBTAINING HINGE AXIS POSITION AND CONDYLE GUIDE INCLINATION FROM A PATIENT

(71) Applicant: The Regents of the University of Michigan, Ann Arbor, MI (US)

(72) Inventors: Junying Li, Ann Arbor, MI (US); Hom-Lay Wang, Ann Arbor, MI (US); Zhaozhao Chen, Ann Arbor, MI (US)

(21) Appl. No.: 17/996,565

(22) PCT Filed: Apr. 15, 2021
(86) PCT No.: PCT/US2021/027487

§ 371 Date: Oct. 19, 2022

Related U.S. Application Data
(60) Provisional application No. 63/012,542, filed on Apr. 20, 2020.

(51) Int. Cl. A61C 9/00; A61C 11/02; A61C 19/045; A61C 19/05; A61C 7/00

(52) U.S. Cl. CPC A61C 9/0053; A61C 11/02; A61C 19/045; A61C 19/05; A61C 7/002

(57) ABSTRACT

The present invention relates to methods and systems for generating a 3-D dental impression with a corresponding hinge axis position and, in certain embodiments, a condylar guide inclination. In some embodiments, an intraoral scanner and a computer processing system are employed to: i) generate upper and lower jaw models, and first and second occlusal 3-D models with different mouth openings (MOs) or functional positions (FPs), ii) align the models to generate a composite 3-D model, iii) calculate a hinge axis position from the composite 3-D model based on the difference in said MOs or FPs, and iv) mount the 3-D dental impression on a virtual articulator (VA) by aligning the hinge axis position to the hinge axis position of the VA.

The present application claims priority to U.S. Provisional application Ser. No. 63/012,542 filed Apr. 20, 2020, which is herein incorporated by reference.

### FIELD OF THE INVENTION

The present invention relates to methods and systems for generating a 3-D dental impression with a corresponding hinge axis position and, in certain embodiments, a condylar guide inclination. In some embodiments, an intraoral scanner and a computer processing system are employed to: i) generate upper and lower jaw models, and first and second occlusal 3-D models with different mouth openings (MOs) or functional positions (FPs), ii) align the models to generate a composite 3-D model, iii) calculate a hinge axis position from the composite 3-D model based on the difference in said MOs or FPS, and iv) mount the 3-D dental impression on a virtual articulator (VA) by aligning the hinge axis position to the hinge axis position of the VA.

### BACKGROUND OF THE INVENTION

Articulator, a mechanical instrument designs to reproduce the position and movement of jaw on stone casts, has been used as an essential tool in both planning and laboratory procedures in dentistry for a long time. With the advancement of technology, researchers are working towards to shift from a product device to its digital alternative, the virtual articulator. Embedded in computer software, the virtual articulator enables dentist and technician to simulate the movement of jaw digitally and integrate occlusion principles into the computer-aided design/computer-aided manufacturing (CAD/CAM) workflows.^{1,2}

To accurately mount an articulator, the position of the maxilla related to hinge axis (an imaginary line crossing through both condyles around which the lower jaw can rotate within the sagittal plane) and the special relationship of the maxillary arch to the orientation plane (a reference plane established on the face by 2 posterior and 1 anterior reference points) must be transferred.³⁻⁶ In the conventional approach, these data are transferred through a facebow. For the mounting of the virtual articulator, techniques with or without a conventional facebow/articulator and casts have been created.⁷⁻¹¹

In the technique introduced by Gartner and Kordass, a mechanical facebow was used to orient the casts on a real articulator, then the articulator and casts were digitally scanned and converted into a virtual articulator.⁷ Subsequently, with the aim of avoiding perform all the conventional procedures and posteriorly scanning the articulator, a modality directly scanning the mechanic facebow and casts was introduced.¹² At present, most commercially available virtual articulators are based on this concept, since no other equipment other than regular devices and lab scanners are needed.

As technology advances, facebow/articulator and casts may eventually be set up digitally. Recently, Solaberrieta and coworkers applied a face-scan, digital impressions of the arch and a scan of the virtual facebow to transfer the actual occlusion relationship digitally.⁸ Other similar techniques have also been reported, having as a common factor the implementation of the face scanning and the virtual facebow.^{10,11}

Nonetheless, there are some disadvantages in the above approaches. Firstly, in the technique that uses conventional articulator, additional steps (conventional mounting procedure) are required before the anatomical and occlusal relationship can be transferred to the virtual articulator. This requires extra chair-side time and potentially may introduce an error during transferring. Secondly, in order to use the above digital articulator, a face scanner/software is a prerequisite, however, this device is not readily available in most dental clinics or labs, making this approach hard to be adopted.

### SUMMARY OF THE INVENTION

The present invention relates to methods and systems for generating a 3-D dental impression with a corresponding hinge axis position and, in certain embodiments, a condylar guide inclination. In some embodiments, an intraoral scanner and a computer processing system are employed to: i) generate upper and lower jaw models, and first and second occlusal 3-D models with different mouth openings (MOs) (e.g., posterior terminal movement) or functional positions (FPs), ii) align the models to generate a composite 3-D model, iii) calculate a hinge axis position from the composite 3-D model based on the difference in said MOs or FPs, and iv) mount the 3-D dental impression on a virtual articulator (VA) by aligning the hinge axis position to the hinge axis position of the VA.

In some embodiments, provided herein are methods of generating a hinge axis position 3-D impression comprising: a) generating from a subject: i) upper and lower jaw teeth and gum (UJTG and LJTG) 3-D models, and ii) first and second occlusal 3-D models with different mouth opening (MOs) or functional positions (FPs), b) aligning the UJTG and LJTG 3-D models and the first and second occlusal 3-D models to generate a composite 3-D model, c) calculating a first hinge axis position from the composite 3-D model based on the difference in the MOs or FPs, and d) generating a hinge axis position 3-D impression (HAP 3-D impression) by combining the first hinge axis position with the UJTG and LJTG 3-D models, wherein the UJTG and LJTG 3-D models are aligned to each other using the first or second occlusal 3-D model.

In certain embodiments, provided herein are methods: using an intraoral scanner and a processing system comprising a computer processor and non-transitory computer memory, for performing the steps of: a) obtaining a first 3-D model of the upper jaw teeth and gums (UJTGs), b) obtaining a second 3-D model of the lower jaw teeth and gums (LJTGs), c) obtaining a third 3-D model that comprises at least a portion of the UJTGs and LJTGs in an occlusal and centric relation (CR) or retruded relation (RR) at a first a first mouth opening (MO) or functional position (FP), d) obtaining a fourth 3-D optical scan that comprises at least a portion of the UJTGs and LJTGs in a CR or RR at a second mouth opening (MO) that is different from the first MO or FP, e) aligning the first, second, third, and fourth 3-D models to generate a composite aligned model; f) calculating a CR or RR hinge axis position based on the difference between the first MO or FP and the second MO or FP; and g) a generating a CR or RR hinge axis position 3-D impression (CorR HAP impression) by combining: A) the CR or RR hinge axis position, the first 3-D model, and the second 3-D model, wherein the first 3D model and the second 3-D model are aligned to each other using the third 3-D model, or the fourth 3-D model.

In particular embodiments, the generating the UJTG and LJTG 3-D models, and first and second occlusal 3-D models, is performed using an intraoral scanner. In other embodiments, the methods further comprises: e) mounting the HAP 3-D impression on a virtual articulator (VA) by aligning the first hinge axis position to the hinge axis position of the VA. In further embodiments, the methods further comprise: obtaining a vertical distance from a chosen point on the HAP 3-D impression to a horizontal reference plane on the subject's face above the nostrils but below the eyes. In some embodiments, the chosen point is an edge of an incisor of the subject. In some embodiments, the methods further comprise: obtaining a vertical distance from a chosen point on said HAP 3-D impression to an anterior reference point on said subject's face.

In some embodiments, the methods further comprise the processing step(s) of: a) positioning the chosen point on the HAP 3-D impression the vertical distance from the VA horizontal upper arm, thereby horizontally mounting the HAP 3-D impression to the VA; and/or b) positioning the anatomic midpoint of the HAP 3-D impression to the mid-point of the VA, thereby vertically mounting the HAP 3-D impression on the VA. In other embodiments, the VA comprises an incisal pin and/or incisal rod, and wherein the mid-point of the VA is defined by the incisal pin and/or the incisal rod. In other embodiments, both a) and b) are conducted, thereby generating a VA with a fully-mounted 3-D impression.

In some embodiments, the methods further comprise: e) generating a protrusive 3-D model; f) adding the first hinge axis position to the UJTG 3-D model to generate a UJTG-hinge axis model with the first hinge axis position; g) adding the first hinge axis position to the LJTG 3-D model to generate a LJTG-hinge axis model with a second hinge axis position; h) aligning the UJTG-hinge axis model with the LJTG-hinge axis model using the protrusive 3-D model, thereby generating a protrusive hinge axis position impression (Pro HAP impression), wherein the Pro HAP impression comprises: A) the first hinge axis position, and B) the second hinge axis position which is at a different position than the first hinge axis position. In certain embodiments, the methods further comprise: i) in the sagittal plane with respect to the Pro HAP impression, measuring an angle between the horizontal reference plane and a line connecting the first and second hinge axis positions, wherein the angle is a condylar guide inclination for the HAP impression when the HAP impression is fully mounted in the VA.

In some embodiments, the only an intraoral scanner is used to take measurements of the subjects teeth and gums. In particular embodiments, the none of the following are used: manual facial measurements, electronic facial scans, face/skull tomography, and face/skull radiography.

In some embodiments, provided herein are methods of generating a hinge axis position 3-D impression comprising: a) performing the following on a subject using an intraoral scanner, wherein the subject has an upper jaw comprising teeth and gums (UJTGs) and a lower jaw comprising teeth and gums (LJTGs): i) a scan of the oral cavity of a subject to generate UJTGs scan data and LJTGs scan data; ii) a scan of the subject's UJTGs and LJTGs with the lower jaw and upper jaw in a first occlusive and centric relation (CR) or retruded relation (RR) to generate first CR or RR scan data, wherein the first occlusive CR or RR position has a first mouth opening (MO) or functional position (FP); and iii) a scan of the subject's UJTGs and LJTGs with the lower jaw and upper jaw in a second occlusive and centric relation (CR) or retruded relation (RR) to generate second CR or RR scan data, wherein second occlusive and CR or RR has a second MO or FP that is different from the first MO or FP, and b) implementing the following processing steps with a processing system that comprises: a computer processor and non-transitory computer memory comprising one or more computer programs for: i) generating 3-D models from intraoral scanner data, ii) aligning 3-D models, and iii) determining a hinge axis position: i) processing the scan data to generate corresponding 3-D models that comprise: a UJTG 3-D model, a LJTG 3-D model, a first CR or RR 3-D model, and a second CR or RR 3-D model, ii) aligning the UJTG 3-D model with the first and second CR or RR 3-D models to generate first and second aligned models respectively; iii) aligning the LJTG 3-D model with the first and second CR or RR 3-D model to generate a third and fourth aligned models respectively, iv) aligning the first, second, third, and fourth aligned models to generate a composite aligned model that comprises: A) a composite UJTG, B) a first composite LJTG with a first tooth, and C) a second composite LJTG with a second tooth which is the same tooth as the first tooth, but is located at a different vertical height with respect to the composite UJTG; v) processing the composite aligned model such that: i) a first reference point is assigned at or near the top of the first tooth (rp1) and the second tooth (rp2); and ii) a second reference point is assigned at or near the bottom of the first tooth (rp3) and the second tooth or in the gums below the first tooth and the second tooth (rp4), and vi) processing the rp1, rp2, rp3, and rp4 such that: A) the following steps are implemented: a) connecting said rp1 and rp3 to generate a first line segment, and connecting said rp2 and rp4 to generate a second line segment; b) a first plane perpendicular to said first line segment is generated that bisects said first line segment, c) a second plane perpendicular to said second line segment is generated, wherein said second plane bisects said second line segment and d) determining a crossing line where said first and second planes intersect, and/or B) the x, y, z coordinates of said first and second lines, said first and second planes, and said crossing line are all calculated mathematically by one or more algorithms, and wherein said crossing line is a CR or RR hinge axis position, and vii) generating a CR or RR hinge axis position 3-D impression (CorR HAP impression) by combining the CR or RR hinge axis position, the UJTG 3-D model, and the LJTG 3-D model, wherein the UJTG-3D model and the LJTG 3-D model aligned to each other using the first CR or RR 3-D model, or the second CR or RR 3-D model.

In particular embodiments, the one or more computer programs further provides a virtual articulator (VA) comprising a VA hinge axis and a VA horizontal upper arm, and wherein the method further comprises the processing step of aligning the CR or RR hinge axis of the 3-D impression with the VA hinge axis, thereby axially mounting the 3-D impression to the VA. In other embodiments, the methods further comprise: obtaining a vertical distance from a chosen point on the 3-D impression to a horizontal reference plane on the subject's face above the nostrils but below the eyes. In other embodiments, the chosen point is an edge of an incisor of the subject.

In certain embodiments, the methods further comprise the processing step(s) of: a) positioning the chosen point on the 3-D impression the vertical distance from the VA horizontal upper arm, thereby horizontally mounting the 3-D impression to the VA; and/or b) positioning the anatomic midpoint of the 3-D impression to the mid-point of the VA, thereby vertically mounting the 3-D impression on the VA. In other embodiments, the VA comprises an incisal pin and/or incisal rod, and wherein the mid-point of the VA is defined by the incisal pin and/or the incisal rod. In particular embodiments, both a) and b) are conducted, thereby generating a VA with a fully-mounted 3-D impression.

In some embodiments, the methods further comprise: a) scanning the subject's UJTGs with hinge and LJTGs using an intraoral scanner with the lower jaw and upper jaw in a occlusive and protrusive position to generate protrusive scan data; b) conducting the following processing steps with the processing system: i) processing the protrusive scan data to generate a protrusive 3-D model; ii) adding the CR or RR hinge axis position to the UJTG-3D model to generate an UJTG hinge axis model with a first hinge axis position, iii) adding the CR or RR hinge axis position to the LJTG-3D model to generate a LJTG hinge axis model with a second hinge axis position, and iv) aligning the UJTG hinge axis model with the LJTG hinge axis model using the protrusive 3-D model, thereby generating a protrusive hinge axis position impression (Pro HAP impression), wherein the Pro HAP impression comprises: A) the first hinge axis position which is at the same location as the CR or RR hinge axis position, and B) the second hinge axis position which is at a different position than the first hinge axis.

In certain embodiments, the one or more computer programs further provides a condylar guide inclination measuring component, and wherein the method further comprises conducting the following processing step with the processing system: in the sagittal plane with respect to the Pro HAP impression, measuring an angle between the horizontal reference plane and line connecting the first and second hinge axis positions, wherein the angle is a condylar guide inclination for the CorR HAP impression when the CoR HAP impression is fully mounted in the VA.

In other embodiments, only an intraoral scanner is used to take measurements of the subjects teeth and gums. In further embodiments, none of the following are used: manual facial measurements, electronic facial scans, face/skull tomography, and face/skull radiography.

In some embodiments, provided herein are systems for generating a hinge axis position 3-D impression comprising: a) non-transitory computer memory comprising one or more computer programs for: i) align 3-D models, and ii) determine a hinge axis position, wherein the one or more computer programs, in conjunction with a computer processor, is/are configured to: i) process: A) UJTGs scan data, B) LJTGs scan data, C) first centric relation (CR) or retruded relation (RR) scan data having a first mouth opening (MO) or functional positions (FP), and D) second centric relation (CR) or retruded relation (RR) scan data having a first mouth opening (MO), thereby generating: corresponding 3-D models that comprise: A) a UJTG 3-D model, B) a LJTG 3-D model, C) a first CR or RR 3-D model, and a D) second CR or RR 3-D model; ii) align the UJTG 3-D model with the first and second CR or RR 3-D models to generate first and second aligned models respectively; iii) align the LJTG 3-D model with the first and second CR or RR 3-D model to generate a third and fourth aligned models respectively, iv) align the first, second, third, and fourth aligned models to generate a composite aligned model that comprises: A) a composite UJTG, B) a first composite LJTG with a first tooth, and C) a second composite LJTG with a second tooth which is the same tooth as the first tooth, but is located at a different vertical height with respect to the composite UJTG; v) process the composite aligned model such that: i) a first reference point is assigned at or near the top of the first tooth (rp1) and the second tooth (rp2); and ii) a second reference point is assigned at or near the bottom of the first tooth (rp3) and the second tooth or in the gums below the first tooth and the second tooth (rp4), and vi) process the rp1, rp2, rp3, and rp4 such that: A) the following steps are implemented: a) connecting said rp1 and rp3 to generate a first line segment, and connecting said rp2 and rp4 to generate a second line segment; b) a first plane perpendicular to said first line is generated, c) a second plane perpendicular to said second line segment is generated, wherein said second plane bisects said second line segment; and d) determine a crossing line where said first and second planes cross, and/or, and/or B) the x, y, z coordinates of the first and second lines, the first and second planes, and the crossing line are all calculated mathematically by one or more algorithms, and wherein the crossing line is a CR or RR hinge axis position, and vii) generating a CR or RR hinge axis position 3-D impression (CorR HAP impression) by combining the C or R hinge axis position, the UJTG 3-D model, and the LJTG 3-D model, wherein the UJTG-3D model and the LJTG 3-D model aligned to each other using the first CR or RR 3-D model, or the second CR or RR 3-D model.

In particular embodiments, the methods further comprise: b) the computer processor. In other embodiments, the one or more computer programs further provides a virtual articulator (VA) comprising a VA hinge axis and a VA horizontal upper arm, and wherein the one or more computer programs are further configured to align the CR or RR hinge axis of the 3-D impression with the VA hinge axis, thereby axially mounting the 3-D impression to the VA. In further embodiments, the one or more computer programs are further configured to receive a vertical distance from a chosen point on the 3-D impression to a horizontal reference plane on the subject's face above the nostrils but below the eyes. In certain embodiments, the chosen point is an edge of an incisor of the subject.

In some embodiments, the one or more computer programs are further configured to: a) position the chosen point on the 3-D impression the vertical distance from the VA horizontal upper arm, thereby horizontally mounting the 3-D impression to the VA; and/or b) position the anatomic midpoint of the 3-D impression to the mid-point of the VA, thereby vertically mounting the 3-D impression on the VA. In other embodiments, the VA comprises an incisal pin and/or incisal rod, and wherein the mid-point of the VA is defined by the incisal pin and/or the incisal rod. In further embodiments, both a) and b) are conducted, thereby generating a VA with a fully-mounted 3-D impression.

In particular embodiments, the one or more computer programs are further configured to: i) process protrusive scan data to generate a protrusive 3-D model; ii) add the CR or RR hinge axis position to the UJTG-3D model to generate an UJTG hinge axis model with a first hinge axis position, iii) add the CR or RR hinge axis position to the LJTG-3D model to generate a LJTG hinge axis model with a second hinge axis position, and iv) align the UJTG hinge axis model with the LJTG hinge axis model using the protrusive 3-D model, thereby generating a protrusive hinge axis position impression (Pro HAP impression), wherein the Pro HAP impression comprises: A) the first hinge axis position which is at the same location as the CR or RR hinge axis position, and B) the second hinge axis position which is at a different position than the first hinge axis.

In certain embodiments, the one or more computer programs further provides a condylar guide inclination measuring component which is configured to conduct the following processing step: in the sagittal plane with respect to the Pro HAP impression, measure an angle between the horizontal reference plane and line connecting the first and second hinge axis positions, wherein the angle is a condylar guide inclination for the CorR HAP impression when the CoR HAP impression is fully mounted in the VA. In some embodiments, the scan data is only provided from an intraoral scanner. In other embodiments, none of the following are used to generate scan data: manual facial measurements, electronic facial scans, face/skull tomography, and face/skull radiography.

### Definitions

As used herein, the terms “host,” “subject” and “patient” refer to any animal, including but not limited to, human and non-human animals (e.g., dogs, cats, cows, horses, sheep, poultry, fish, etc.) that is studied, analyzed, tested, diagnosed or treated. As used herein, the terms “host,” “subject” and “patient” are used interchangeably, unless indicated otherwise. In certain embodiments, the subject is a human.

As used herein, a “UJTG 3-D model” refers to a computer generated three-dimensional model of a person's upper jaw teeth and gums (see, e.g., FIG. 1A). A UJTG 3-D model is generated by scanning the person's intraoral cavity using an intraoral scanner such that scan data is generated of the person's upper teeth and gums, which is then converted by a computer program to a three-dimensional model of the person's upper teeth and gums.

As used herein, a “LJTG 3-D model” refers to a computer generated three-dimensional model of a person's lower jaw teeth and gums (see, e.g., FIG. 1B). A LJTG 3-D model is generated by scanning the person's intraoral cavity using an intraoral scanner such that scan data is generated of the person's lower teeth and gums, which is then converted by a computer program to a three-dimensional model of the person's lower teeth and gums.

As used herein, a “first CR or RR 3-D model” refers to a computer generated three dimensional model generated from first CR or RR scan data, where “CR” stands for centric relation and “RR” stands for retruded relation. A first CR 3-D model (see, e.g., FIG. 1C) is generated by scanning a person's UJTGs (upper jaw teeth and gums) and LJTGs (lower jaw teeth and gums) with the lower jaw and upper jaw in a first occlusive and centric relation (CR) to generate first CR scan data where the first occlusive CR position has a first mouth opening (MO). A first RR 3-D model is generated by scanning a person's UJTGs (upper jaw teeth and gums) and LJTGs (lower jaw teeth and gums) with the lower jaw and upper jaw in a first occlusive and retruded relation (RR) to generate first RR scan data, where the first occlusive RR position has a first mouth opening (MO).

As used herein, a “second CR or RR 3-D model” refers to a computer generated three dimensional model generated from second CR or RR scan data, where “CR” stands for centric relation and “RR” stands for retruded relation. A second CR 3-D model (see, e.g., FIG. 1D) is generated by scanning a person's UJTGs (upper jaw teeth and gums) and LJTGs (lower jaw teeth and gums) with the lower jaw and upper jaw in a second occlusive and centric relation (CR) to generate second CR scan data, where the second occlusive CR has a second mouth opening (MO) different from the first MO. A second R 3-D model is generated by scanning a person's UJTGs (upper jaw teeth and gums) and LJTGs (lower jaw teeth and gums) with the lower jaw and upper jaw in a second occlusive and retruded relation (RR) to generate second RR scan data, where the second occlusive RR has a first mouth opening (MO) different from the first MO.

As used herein, a “protrusive 3-D model” refers to a computer generated three dimensional model generated from protrusive scan data. A protrusive 3-D model (see, e.g., FIG. 1E) is generated by scanning a person's UJTGs (upper jaw teeth and gums) and LJTGs (lower jaw teeth and gums) with the lower jaw and upper jaw in an occlusive and protrusive position to generate protrusive scan dat.

As used herein, a “mechanical dental articulator” (or “real dental articulator”) is a mechanical hinged device used in dentistry to which plaster casts of the maxillary (upper) and mandibular (lower) jaw are fixed, reproducing some or all the movements of the mandible in relation to the maxilla. The human maxilla is fixed and the scope of movement of the mandible (and therefore the dentition) is dictated by the position and movements of the bilateral temperomandibular joints, which sit in the glenoid fossae in the base of the skull. The temperomandibular joints are not a simple hinge but rotate and translate forward when the mouth is opened. The principal movements reproduced are: at rest (centric jaw relation), in protrusion (to bite), from side to side (lateral excursion) to chew, in retrusion, and any possible combination of these. Counter-intuitively, it is the cast of the maxilla which moves relative to the cast of the mandible and the articulator. A mechanical articulator assists in the accurate fabrication of the biting surfaces of removable prosthodontic appliances (dentures), fixed prosthodontic restorations (implants, crowns, bridges, inlays and onlays) and orthodontic appliances. Used with skill it ensures correct interdigitation of the teeth and an anatomically functional biting plane. This means less occlusal adjustments before and after fitting dental appliances and fewer chronic conflicts between the teeth and the jaw joints.

As used herein, a “virtual articulator” (VA) is a computer implemented version of a mechanical articulator. Virtual Articulator software is commercially available including, for example, Exocad (Exocad GmbH), DentalDesigner (3Shape), PlaneSystem (Zirkonzahn), and Dento-Facial Analyzer (Panadent).

### DESCRIPTION OF THE DRAWINGS

FIG. 1 shows 3-D models constructed from optical scans of jaws and occlusion. FIG. 1A shows an exemplary upper teeth and gums 3-model. FIG. 1B shows an exemplary upper teeth and gums 3-D model. FIG. 1C shows an exemplary occlusal and centric scan 3-D model. FIG. 1D shows an exemplary occlusal and centric 3-D model at a different MO than FIG. 1C. FIG. 1E shows an exemplary occlusal and protrusive 3-D model.

FIG. 2 shows an alignment (superimposition) of 3D models to generate a composite 3-D model.

FIG. 3 shows exemplary point markers on lower jaw scans.

FIG. 4 shows a virtual kinematic face bow.

FIG. 5 shows an alignment of VKF to [symbol] . FIG. 5A shows a frontal view, and FIG. 5B shows a side view.

FIG. 6 shows exemplary steps for locating a hinge axis.

FIG. 7 shows an exemplary schematic of aligning a model to virtual articulator.

FIG. 8a shows an exemplary distance from incisor edge to horizontal reference plane (DIH) on a subject's face between the eyes and nostrils. FIG. 8B shows an exemplary methods to adjust the vertical position of model.

FIG. 9 shows superimposing upper and lower jaw models according to protrusion bite scan.

FIG. 10 shows an exemplary method for measuring condylar guide inclination.

FIG. 11 shows sagittal planes that crossing left and right temporomandibular joints of virtual articular (VA).

### DETAILED DESCRIPTION OF THE INVENTION

The present invention relates to methods and systems for generating a 3-D dental impression with a corresponding hinge axis position and, in certain embodiments, a condylar guide inclination. In some embodiments, an intraoral scanner and a computer processing system are employed to: i) generate upper and lower jaw models, and first and second occlusal 3-D models with different mouth opening (MOs) or functional positions (FPs), ii) align the models to generate a composite 3-D model, iii) calculate a hinge axis position from the composite 3-D model based on the difference in said MOs or FPs, and iv) mount the 3-D dental impression on a virtual articulator (VA) by aligning the hinge axis position to the hinge axis position of the VA.

The dental articulator is a device to simulate the occlusion of a patient, which is a fundamental tool for dental treatment. The virtual articulator is a digital counterpart of a real (manual) dental articulator. To accurately reproduce the position and movement of the jaw, the occlusal relationship should be recorded from the patient and transferred to the articulator, and this procedure is called mounting an articulator. At present, available methods of mounting a virtual articulator have to rely on conventional mounting approach or face scan. The methods and systems described herein allow a virtual articulator to be mounted (e.g., using only data from an intraoral scanner).

The following provides an exemplary description of how to determine a hinge axis, mount a virtual articulator, and find the condylar guide inclination (e.g., only using intraoral scanner data).

I. Initial Intraoral Device Scans and Model Generation

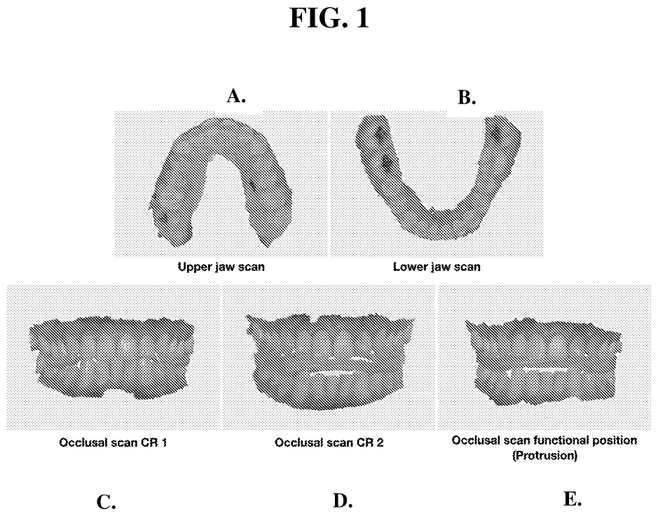

First, one obtains optical scans of jaws and occlusion using an intraoral scanner. Optical scans of an upper jaw (with teeth and gums; UJTG) are scanned (model shown in FIG. 1A) and lower jaw (with teeth and gums; LJTG) are scanned (model shown in FIG. 1B). A patient's jaw is positioned into centric relation (CR), and one applies bite registration material to record the CR. Scan both maxillary and mandibular jaws to get the first occlusion scan (OSCR1), as shown in FIG. 1C. Use bite registration material to record another CR with a varied mouth opening (MO). Scan both maxillary and mandibular jaws to obtain the second occlusion scan (OSCR2), as shown in FIG. 1D. Next, put the lower jaw into protrusion position, apply bite registration material, and scan both maxillary and mandibular jaws to get the third occlusion scan (OSP), as shown in FIG. 1E. These scans are converted into digital three-dimensional models as shown in FIG. 1. It is noted that Retruded Relation (RR) can used as an alternative to centric relation.

II. Obtain Distance from Reference Point to Horizontal Reference Plane

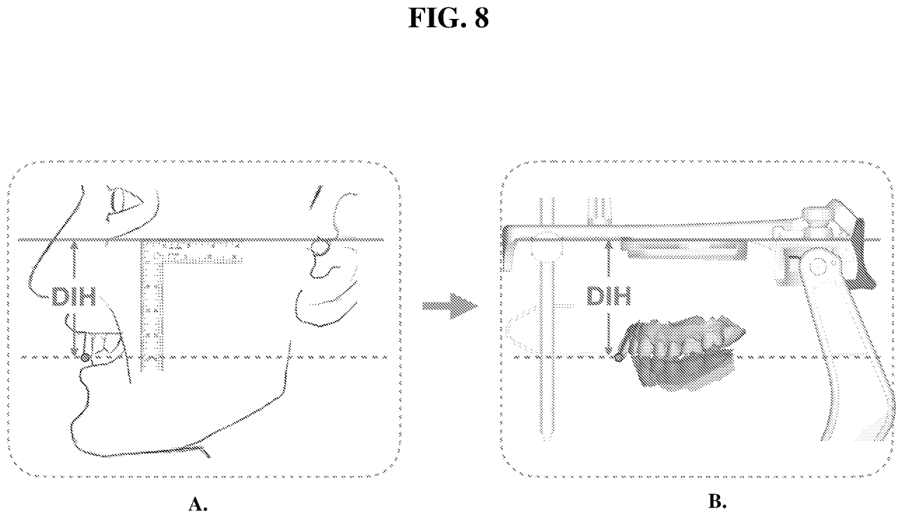

Next, obtain a vertical distance from a point on a tooth or gums (e.g., central incisor edge) to horizontal reference plane. This step can be done by using a ruler when the patient is smiling as shown in FIG. 8a.

III. Aligning/Superimposing Scans and Adding Reference Points

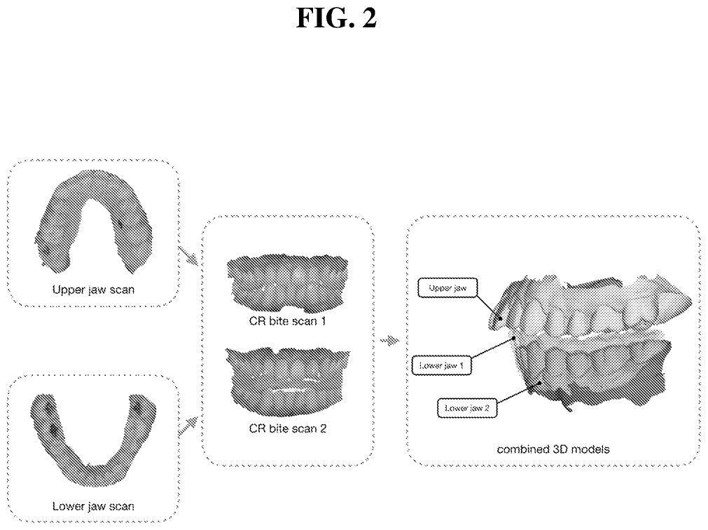

Next, align OS_{CR1} 3-D model and OS_{CR2} 3-Model to UJTGs model by matching the anatomic structures of upper jaw. Then align LJTGs model to OS₁ 3-D model by matching the anatomic structures of lower jaw. Align a duplication of LJTG to OS₂ 3-D model. The firstly aligned lower jaw model is LJL1TGs, the other one is LJ₂ TGs; see FIG. 2. It is noted that part II. above can be omitted if OS1 and OS2 can provide enough anatomic landmarks of lower jaw for locating the hinge axis.

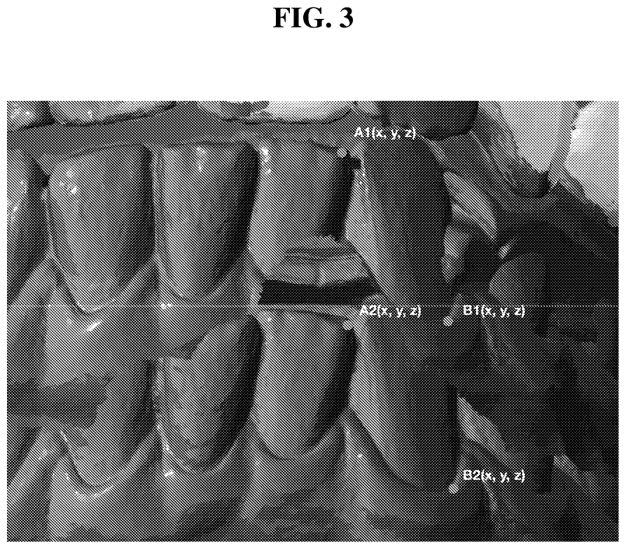

Next, choose a landmark on the 3D model of LJ₁TG, add a point marker (A₁) on it. Add another maker on the same position of LJ₂TG. Choose another landmark on LJ₁TG and LJ₂TG, add other two corresponding point markers (B₁, B₂) (see FIG. 3). From A₁, A₂, B₁, and B₂, the 3D position of hinge axis can be located.

IV. Locating the Hinge Axis

There are two general approaches to locate hinge axis: 1) manual approach, and 2) automatic (algorithm) approach.

A. Acquiring Position of Hinge Axis Manually

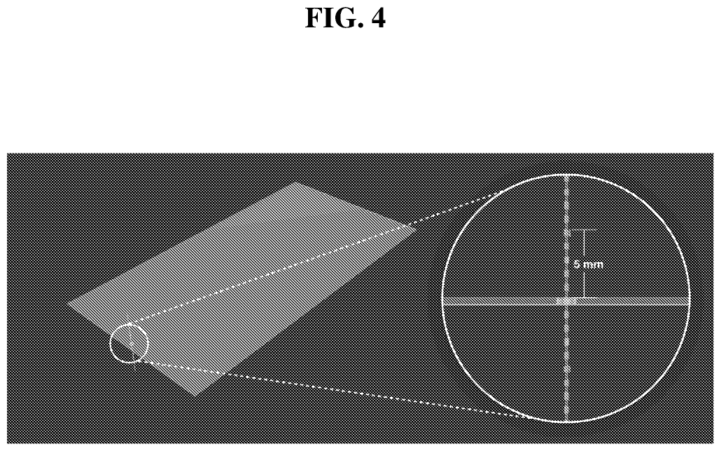

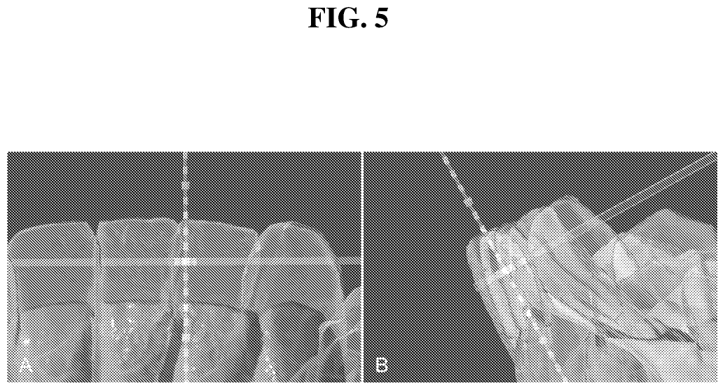

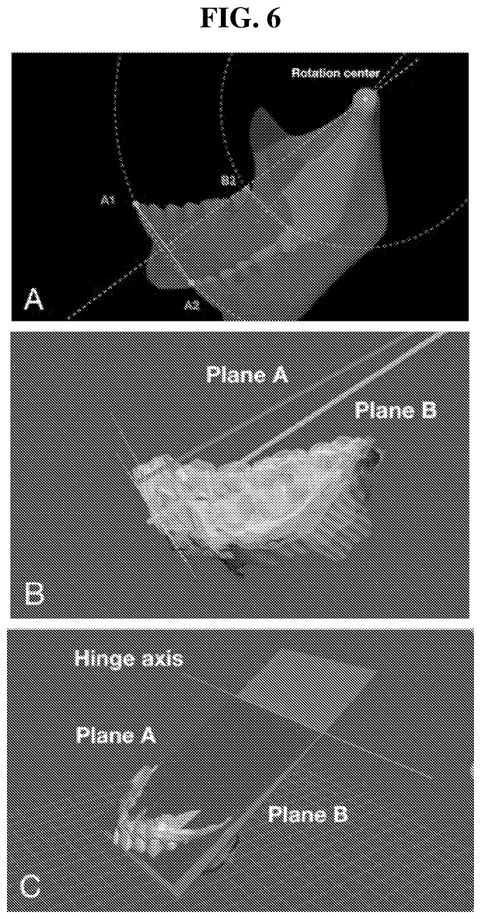

In work conducted during the development of embodiments herein a tool named virtual kinematic facebow (VKF) was constructed to locate hinge axis manually. The VKF has a plane and a probe. The probe is perpendicular to the plane and has scales on each side (see FIG. 4. Align the probe to [symbol] , keep the VKF plane as the perpendicular bisector of [symbol] (see FIG. 5). Make a duplicate of VKF, align it to [symbol] . Plane A is the perpendicular bisector of [symbol] and plane B is the perpendicular bisector of [symbol] . Given that in CR, the lower draw rotates around the transverse horizontal axis, the hinges axis can be found as the intersection of plane A and plan B (FIG. 6).

B. Acquiring Position of Hinge Axis Automatically (Algorithm)

Acquire the 3-dimensional spatial coordinate of A₁ (xₐ,yₐ₁,zₐ₁), A₂ (xₐ,yₐ₂,zₐ₂), B1 (x_{b1},y_{b1},z_{b1}), and B2 (x_{b2},y_{b2},z_{b2}). The 3-dimensional spatial expression of the hinge axis can be defined as follows:

Midpoint between A₁(xₐ₁,yₐ₁,zₐ₁), A₂(xₐ₂,yₐ₂,zₐ₂):

$${A}_{m} ( \frac{{x}_{a 1} + {x}_{a 2}}{2} , \frac{{y}_{a 1} + {y}_{a 2}}{2} , \frac{{z}_{a 1} + {z}_{a 2}}{2} )$$

The vector that connects A₁ and A₂ is:

[symbol]

=(xₐ₂−xₐ₁,yₐ₂−yₐ₁,zₐ₂−zₐ₁)=(a,b,c)

The perpendicular bisector follows this equation:

ax+by+cz=d

To solve for d, plug Aₘ into the above equation:

$$d = \frac{( {x}_{a 1} + {x}_{a 2} ) \cdot ( {x}_{a 2} - {x}_{a 1} )}{2} + \frac{( {y}_{a 1} + {y}_{a 2} ) \cdot ( {y}_{a 2} - {y}_{a 1} )}{2} + \frac{( {z}_{a 1} + {z}_{a 2} ) \cdot ( {z}_{a 2} - {z}_{a 1} )}{2}$$

$$d = \frac{{x}_{a 2}^{2} - {x}_{a 1}^{2}}{2} + \frac{{y}_{a 2}^{2} - {y}_{a 1}^{2}}{2} + \frac{{z}_{a 2}^{2} - {z}_{a 1}^{2}}{2}$$

The perpendicular bisector for points B₁ and B₂ can be derived similarly
Given two planes a₁x+b₁y+c₁z=d₁ and a₂x+b₂y+c₂z=d₂,
The vector is parallel to the intersect of the two planes:

v=(a₁,b₁,c₁)×(a₂,b₂,c₂)=(b₁c₂−c₁b₂,c₁a₂−a₁c₂,a₁b₂−b₁a₂)=(l,m,n)

Find an arbitrary point on the intersect:

$$plug z = 0 into {a}_{1} x + {b}_{1} y + {c}_{1} z = {d}_{1} and {a}_{2} x + {b}_{2} y + {c}_{2} z = {d}_{2} ; and then solve for x = {x}_{0} and y = {y}_{0} ;$$

$$Then$$

$$[ \begin{matrix}{x}_{0} \\ {y}_{0} \\ 0\end{matrix} ] + t [ \begin{matrix}l \\ m \\ n\end{matrix} ] , t ∈ ℝ is the expression for the intersect ( hinge axis )$$

According to above expression, the 3D position of hinge axis can be calculated by computer.

V. Mount 3D Jaw Models on Virtual Articulator (VA)

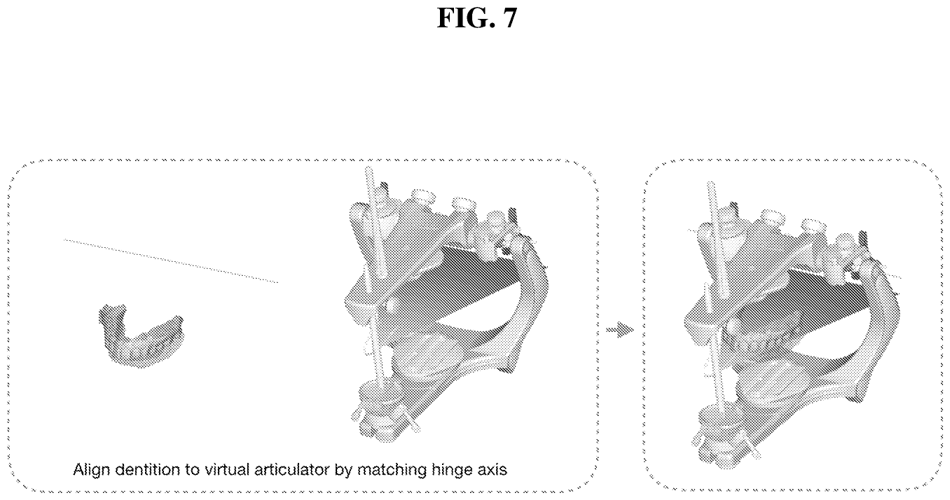

Alinge the models to the VA by matching the hinge axis of models to that of VA (see FIG. 7). Rotate model around hinge axis, until the distance from model incisors to the upper arm of VA equals to distance (e.g., DIH) which is obtained as described above (see FIG. 8a). Next, align the midline of the model to VA, which will put the jaw models in the right position.

VI. Acquiring Left and Right Condylar Guide Inclinations

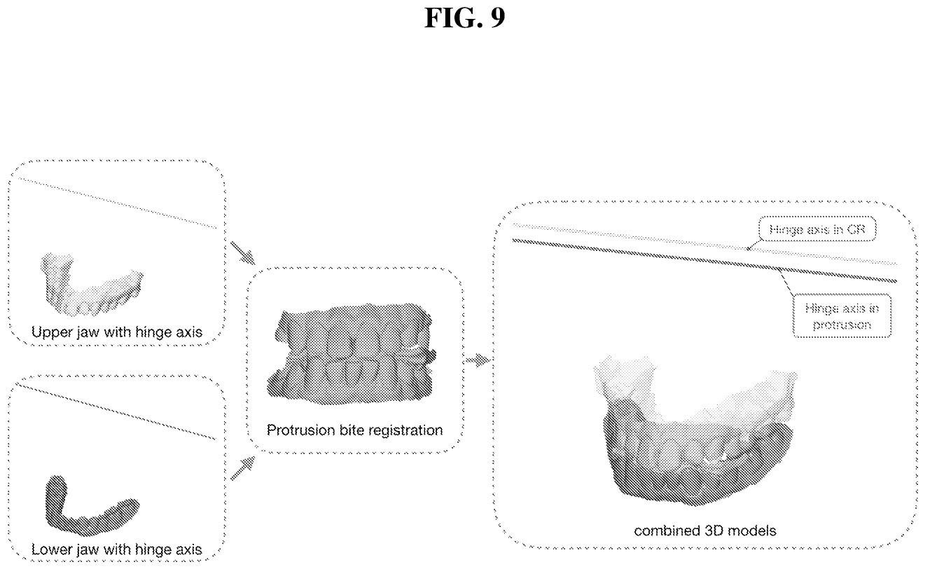

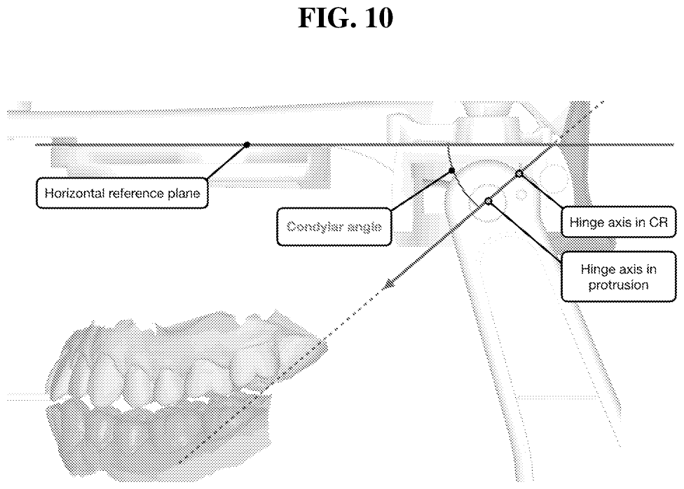

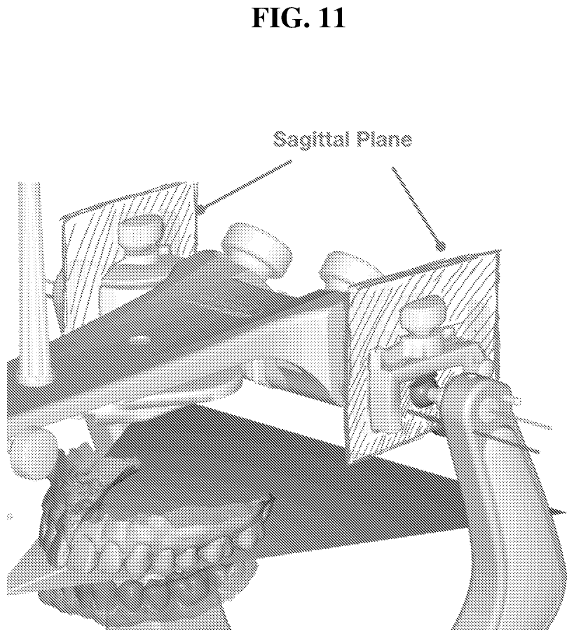

Create a lower jaw model with hinge axis, align it to upper jaw model by matching OS_{P}(FIG. 9). Now, the hinge axis attached to the lower jaw is in a protrusion position. The condylar guide inclination can be measured in a sagittal plane (see FIGS. 10 and 11), as the angle between horizontal reference plane and the line passing hinge axis in CR and hinge axis in protrusion. Left and right condylar guide inclination should be measured in according sagittal plane that cross left and right temporomandibular joints of VA (see FIG. 11).

### REFERENCES

1. Kordass B, Gartner C, Sohnel A, Bisler A, Voss G, Bockholt U, et al. The virtual articulator in dentistry: concept and development. Dent Clin North Am 2002; 46:493-506.
2. Koralakunte P R, Aljanakh M. The role of virtual articulator in prosthetic and restorative dentistry. J Clin Diagn Res 2014; 87:ZE25-8.
3. Lauritzen A G, Bodner G H. Variations in location of arbitrary and true hinge axis points. J Prosthet Dent 1961; 11:224-9.
4. Walker P M. Discrepancies between arbitrary and true hinge axes. J Prosthet Dent 1980; 43:279-85.
5. Pitchford J H. A reevaluation of the axis-orbital plane and the use of orbitale in a facebow transfer record. J Prosthet Dent 1991; 66:349-55.
6. Bailey J O Jr, Nowlin T P. Evaluation of the third point of reference for mounting maxillary casts on the Hanau articulator. J Prosthet Dent 1984; 51:199-201.
7. Gartner C, Kordass B. The virtual articulator: development and evaluation. Int J Comput Dent 2003 January; 6:11-24.
8. Solaberrieta E, Garmendia A, Minguez R, Brizuela A, Pradies G. Virtual facebow technique. J Prosthet Dent 2015; 114:751-5.
9. Lam W Y H, Hsung R T C, Choi W W S, Luk H W K, Pow E H N. A 2-part facebow for CAD-CAM dentistry. J Prosthet Dent 2016; 116:843-7.
10. Lam W Y H, Hsung R T C, Choi W W S, Luk H W K, Cheng L Y Y, Pow E H N. A clinical technique for virtual articulator mounting with natural head position by using calibrated stereophotogrammetry. J Prosthet Dent 2018; 119:902-8;
11. Solaberrieta E, Minguez R, Barrenetxea L, Etxaniz O. Direct transfer of the position of digitized casts to a virtual articulator. J Prosthet Dent 2013; 109:411-4.
12. Solaberrietaa E, Minguezb R, Etaxanizc O, Barrenetxea L. Improving the Digital Workflow: Direct Transfer from Patient to Virtual Articulator. Int J Comput Dent 2013; 16:285-92.

All publications and patents mentioned in the above specification are herein incorporated by reference. Various modifications and variations of the described compositions and methods of the invention will be apparent to those skilled in the art without departing from the scope and spirit of the invention. Although the invention has been described in connection with specific preferred embodiments, it should be understood that the invention as claimed should not be unduly limited to such specific embodiments. Indeed, various modifications of the described modes for carrying out the invention that are obvious to those skilled in the relevant fields are intended to be within the scope of the present invention.

We claim:

1. A method of generating a hinge axis position 3-D impression comprising:
a) generating from a subject: i) upper and lower jaw teeth and gum (UJTG and LJTG) 3-D models, and ii) first and second occlusal 3-D models with different mouth openings (MOs) or functional positions (FPs),
b) aligning said UJTG and LJTG 3-D models and the first and second occlusal 3-D models to generate a composite 3-D model,
c) calculating a first hinge axis position from the composite 3-D model based on the difference in said MOs or FPs, and
d) generating a hinge axis position 3-D impression (HAP 3-D impression) by combining said first hinge axis position with said UJTG and LJTG 3-D models,
wherein said UJTG and LJTG 3-D models are aligned to each other using said first or second occlusal 3-D model.

2. The method of claim 1, wherein said generating said UJTG and LJTG 3-D models, and first and second occlusal 3-D models, is performed using an intraoral scanner.

3. The method of claim 1, wherein said methods further comprises: e) mounting said HAP 3-D impression on a virtual articulator (VA) by aligning said first hinge axis position to the hinge axis position of the VA.

4. The method of claim 1, further comprising: obtaining a vertical distance from a chosen point on said HAP 3-D impression to an anterior reference point on said subject's face.

5. The method of claim 4, wherein said chosen point is an edge of an incisor of said subject.

6. The method of claim 4, further comprising the processing step(s) of:
a) positioning said chosen point on said HAP 3-D impression said vertical distance from said VA horizontal upper arm, thereby horizontally mounting said HAP 3-D impression to said VA; and/or
b) positioning the midpoint of said HAP 3-D impression to the mid-point of said VA, thereby vertically mounting said HAP 3-D impression on said VA.

7. The method of claim 6, wherein said VA comprises an incisal pin and/or incisal rod, and wherein said mid-point of said VA is defined by said incisal pin and/or said incisal rod.

8. The method of claim 6, wherein both a) and b) are conducted, thereby generating a VA with a fully-mounted 3-D impression.

9. The method of claim 1, further comprising:
e) generating a protrusive occlusal 3-D model;
f) adding said first hinge axis position to said UJTG 3-D model to generate a UJTG-hinge axis model with said first hinge axis position;
g) adding said first hinge axis position to said LJTG 3-D model to generate a LJTG-hinge axis model with a second hinge axis position;
h) aligning said UJTG-hinge axis model with said LJTG-hinge axis model using said protrusive 3-D model, thereby generating a protrusive hinge axis position impression (Pro HAP impression), wherein said Pro HAP impression comprises: A) said first hinge axis position, and B) said second hinge axis position which is at a different position than said first hinge axis position.

10. The method of claim 9, further comprising i) in the sagittal plane with respect to said Pro HAP impression, measuring an angle between said horizontal reference plane and a line connecting said first and second hinge axis positions, wherein said angle is a condylar guide inclination for said HAP impression when said HAP impression is fully mounted in said VA.

11. The method of any of claims 1-10, wherein only an intraoral scanner is used to take measurements of said subject's teeth and gums.

12. The method of any of claims 1-10, wherein none of the following are used: manual facial measurements, electronic facial scans, face/skull tomography, and face/skull radiography.

13. A method comprising: using an intraoral scanner and a processing system comprising a computer processor and non-transitory computer memory, for performing the steps of:
a) obtaining a first 3-D model of the upper jaw teeth and gums (UJTGs),
b) obtaining a second 3-D model of the lower jaw teeth and gums (LJTGs),
c) obtaining a third 3-D model that comprises at least a portion of said UJTGs and LJTGs in an occlusal and centric relation (CR) or retruded relation (RR) at a first mouth opening (MO) or functional position (JM),
d) obtaining a fourth 3-D optical scan that comprises at least a portion of said UJTGs and LJTGs in a CR or RR at a second mouth opening (MO) or FP that is different from said first MO,
e) aligning said first, second, third, and fourth 3-D models to generate a composite aligned model;
f) calculating a CR or RR hinge axis position based on the difference between said first MO or FP and said second MO or FP; and
g) generating a CR or RR hinge axis position 3-D impression (CorR HAP impression) by combining: A) said CR or RR hinge axis position, said first 3-D model, and said second 3-D model, wherein said first 3D model and said second 3-D model are aligned to each other using said third 3-D model, or said fourth 3-D model.

14. A method of generating a hinge axis position 3-D impression comprising:
a) performing the following on a subject using an intraoral scanner, wherein the subject has an upper jaw comprising teeth and gums (UJTGs) and a lower jaw comprising teeth and gums (LJTGs):
i) a scan of the oral cavity of a subject to generate UJTGs scan data and LJTGs scan data;
ii) a scan of said subject's UJTGs and LJTGs with said lower jaw and upper jaw in a first occlusive and centric relation (CR) or retruded relation (RR) to generate first CR or RR scan data, wherein said first occlusive CR or RR position has a first mouth opening (MO) or functional position (FP); and
iii) a scan of said subject's UJTGs and LJTGs with said lower jaw and upper jaw in a second occlusive and centric relation (CR) or retruded relation (RR) to generate second CR or RR scan data, wherein second occlusive and CR or RR has a second MO or FP that is different from said first MO or FP, and
b) implementing the following processing steps with a processing system that comprises: a computer processor and non-transitory computer memory comprising one or more computer programs for: i) generating 3-D models from intraoral scanner data, ii) aligning 3-D models, and iii) determining a hinge axis position:
i) processing said scan data to generate corresponding 3-D models that comprise: a UJTG 3-D model, a LJTG 3-D model, a first CR or RR 3-D model, and a second CR or RR 3-D model,
ii) aligning said UJTG 3-D model with said first and second CR or RR 3-D models to generate first and second aligned models respectively;
iii) aligning said LJTG 3-D model with said first and second CR or RR 3-D model to generate a third and fourth aligned models respectively,
iv) aligning said first, second, third, and fourth aligned models to generate a composite aligned model that comprises: A) a composite UJTG, B) a first composite LJTG with a first tooth, and C) a second composite LJTG with a second tooth which is the same tooth as said first tooth, but is located at a different vertical height with respect to said composite UJTG;
v) processing said composite aligned model such that: i) a first reference point is assigned at or near the top of said first tooth (rp1) and said second tooth (rp2); and ii) a second reference point is assigned at or near the bottom of said first tooth (rp3) and said second tooth or in the gums below said first tooth and said second tooth (rp4), and
vi) processing said rp1, rp2, rp3, and rp4 such that:
A) the following steps are implemented:
a) connecting said rp1 and rp3 to generate a first line segment, and connecting said rp2 and rp4 to generate a second line segment;
b) a first plane perpendicular to said first line segment is generated that bisects said first line segment,
c) a second plane perpendicular to said second line segment is generated, wherein said second plane bisects said second line segment and
d) determining a crossing line where said first and second planes intersect, and/or
B) the x, y, z coordinates of said first and second lines, said first and second planes, and said crossing line are all calculated mathematically by one or more algorithms, and
wherein said crossing line is a CR or RR hinge axis position, and
vii) generating a CR or RR hinge axis position 3-D impression (CorR HAP impression) by combining said CR or RR hinge axis position, said UJTG 3-D model, and said LJTG 3-D model, wherein said UJTG-3D model and said LJTG 3-D model aligned to each other using said first CR or RR 3-D model, or said second CR or RR 3-D model.

15. The method of claim 14, wherein said one or more computer programs further provides a virtual articulator (VA) comprising a VA hinge axis and a VA horizontal upper arm, and wherein the method further comprises the processing step of aligning said CR or RR hinge axis of said 3-D impression with said VA hinge axis, thereby axially mounting said 3-D impression to said VA.

16. The method of claim 15, further comprising: obtaining a vertical distance from a chosen point on said 3-D impression to a horizontal reference plane on said subject's face above the nostrils but below the eyes.

17. The method of claim 16, wherein said chosen point is an edge of an incisor of said subject.

18. The method of claim 16, further comprising the processing step(s) of:
a) positioning said chosen point on said 3-D impression said vertical distance from said VA horizontal upper arm, thereby horizontally mounting said 3-D impression to said VA; and/or
b) positioning the anatomic midpoint of said 3-D impression to the mid-point of said VA, thereby vertically mounting said 3-D impression on said VA.

19. The method of claim 18, wherein said VA comprises an incisal pin and/or incisal rod, and wherein said mid-point of said VA is defined by said incisal pin and/or said incisal rod.

20. The method of claim 18, wherein both a) and b) are conducted, thereby generating a VA with a fully-mounted 3-D impression.

21. The method of claim 20, further comprising:
a) scanning said subject's UJTGs with hinge and LJTGs using an intraoral scanner with said lower jaw and upper jaw in an occlusive and protrusive position to generate protrusive scan data;
b) conducting the following processing steps with said processing system:
i) processing said protrusive scan data to generate a protrusive 3-D model;
ii) adding said CR or RR hinge axis position to said UJTG-3D model to generate an UJTG hinge axis model with a first hinge axis position,
iii) adding said CR or RR hinge axis position to said LJTG-3D model to generate a LJTG hinge axis model with a second hinge axis position, and
iv) aligning said UJTG hinge axis model with said LJTG hinge axis model using said protrusive 3-D model, thereby generating a protrusive hinge axis position impression (Pro HAP impression), wherein said Pro HAP impression comprises: A) said first hinge axis position which is at the same location as said CR or RR hinge axis position, and B) said second hinge axis position which is at a different position than said first hinge axis.

22. The method of claim 21, wherein said one or more computer programs further provides a condylar guide inclination measuring component, and wherein the method further comprises conducting the following processing step with said processing system: in the sagittal plane with respect to said Pro HAP impression, measuring an angle between said horizontal reference plane and line connecting said first and second hinge axis positions, wherein said angle is a condylar guide inclination for said CorR HAP impression when said CoR HAP impression is fully mounted in said VA.

23. The method of any of claims 14-22, wherein only an intraoral scanner is used to take measurements of said subjects teeth and gums.

24. The method of any of claims 14-22, wherein none of the following are used: manual facial measurements, electronic facial scans, face/skull tomography, and face/skull radiography.

25. A system for generating a hinge axis position 3-D impression comprising:
a) non-transitory computer memory comprising one or more computer programs for: i) align 3-D models, and ii) determine a hinge axis position,
wherein said one or more computer programs, in conjunction with a computer processor, is/are configured to:
i) process: A) UJTGs scan data, B) LJTGs scan data, C) first centric relation (CR) or retruded relation (RR) scan data having a first mouth opening (MO) or functional position (FP), and D) second centric relation (CR) or retruded relation (RR) scan data having a first mouth opening (MO) or functional position (FP), thereby generating: corresponding 3-D models that comprise: A) a UJTG 3-D model, B) a LJTG 3-D model, C) a first CR or RR 3-D model, and a D) second CR or RR 3-D model;
ii) align said UJTG 3-D model with said first and second CR or RR 3-D models to generate first and second aligned models respectively;
iii) align said LJTG 3-D model with said first and second CR or RR 3-D model to generate a third and fourth aligned models respectively,
iv) align said first, second, third, and fourth aligned models to generate a composite aligned model that comprises: A) a composite UJTG, B) a first composite LJTG with a first tooth, and C) a second composite LJTG with a second tooth which is the same tooth as said first tooth, but is located at a different vertical height with respect to said composite UJTG;
v) process said composite aligned model such that: i) a first reference point is assigned at or near the top of said first tooth (rp1) and said second tooth (rp2); and ii) a second reference point is assigned at or near the bottom of said first tooth (rp3) and said second tooth or in the gums below said first tooth and said second tooth (rp4), and
vi) process said rp1, rp2, rp3, and rp4 such that:
A) the following steps are implemented:
a) connecting said rp1 and rp3 to generate a first line segment, and connecting said rp2 and rp4 to generate a second line segment;
b) a first plane perpendicular to said first line is generated,
c) a second plane perpendicular to said second line segment is generated, wherein said second plane bisects said second line segment; and
d) determine a crossing line where said first and second planes cross, and/or
B) the x, y, z coordinates of said first and second lines, said first and second planes, and said crossing line are all calculated mathematically by one or more algorithms, and wherein said crossing line is a CR or RR hinge axis position, and
vii) generating a CR or RR hinge axis position 3-D impression (CorR HAP impression) by combining said C or R hinge axis position, said UJTG 3-D model, and said LJTG 3-D model, wherein said UJTG-3D model and said LJTG 3-D model aligned to each other using said first CR or RR 3-D model, or said second CR or RR 3-D model.

26. The system of claim 25, further comprising: b) said computer processor.

27. The system of claim 25, wherein said one or more computer programs further provides a virtual articulator (VA) comprising a VA hinge axis and a VA horizontal upper arm, and wherein said one or more computer programs are further configured to align said CR or RR hinge axis of said 3-D impression with said VA hinge axis, thereby axially mounting said 3-D impression to said VA.

28. The system of claim 25, wherein said one or more computer programs are further configured to receive a vertical distance from a chosen point on said 3-D impression to a horizontal reference plane on said subject's face above the nostrils but below the eyes.

29. The system of claim 28, wherein said chosen point is an edge of an incisor of said subject.

30. The system of claim 28, wherein said one or more computer programs are further configured to:
a) position said chosen point on said 3-D impression said vertical distance from said VA horizontal upper arm, thereby horizontally mounting said 3-D impression to said VA; and/or
b) position the anatomic midpoint of said 3-D impression to the mid-point of said VA, thereby vertically mounting said 3-D impression on said VA.

31. The system of claim 30, wherein said VA comprises an incisal pin and/or incisal rod, and wherein said mid-point of said VA is defined by said incisal pin and/or said incisal rod.

32. The system of claim 30, wherein both a) and b) are conducted, thereby generating a VA with a fully-mounted 3-D impression.

33. The system of claim 32, wherein said one or more computer programs are further configured to:
i) process protrusive scan data to generate a protrusive 3-D model;
ii) add said CR or RR hinge axis position to said UJTG-3D model to generate an UJTG hinge axis model with a first hinge axis position,
iii) add said CR or RR hinge axis position to said LJTG-3D model to generate a LJTG hinge axis model with a second hinge axis position, and
iv) align said UJTG hinge axis model with said LJTG hinge axis model using said protrusive 3-D model, thereby generating a protrusive hinge axis position impression (Pro HAP impression), wherein said Pro HAP impression comprises: A) said first hinge axis position which is at the same location as said CR or RR hinge axis position, and B) said second hinge axis position which is at a different position than said first hinge axis.

34. The system of claim 32, wherein said one or more computer programs further provides a condylar guide inclination measuring component which is configured to conduct the following processing step: in the sagittal plane with respect to said Pro HAP impression, measure an angle between said horizontal reference plane and line connecting said first and second hinge axis positions, wherein said angle is a condylar guide inclination for said CorR HAP impression when said CoR HAP impression is fully mounted in said VA.

35. The system of any of claims 25-34, wherein scan data is only provided from an intraoral scanner.

36. The system of any of claims 25-34, wherein none of the following are used to generate scan data: manual facial measurements, electronic facial scans, face/skull tomography, and face/skull radiography.
